(19) United States
(12) Patent Application Publication
(10) Pub. No.: US 2003/0222972 A1
(43) Pub. Date: Dec. 4, 2003

(54) Device with repeat function for receiver apparatus, in partcular video, and apparatus equipped therewith

(76) Inventor: Bernard Hodac, Paris (FR)

Correspondence Address: YOUNG & THOMPSON, 745 SOUTH 23RD STREET 2ND FLOOR, ARLINGTON, VA, 22202

(21) Appl. No.: 10/296,590

(22) PCT Filed: May 26, 2001
(86) PCT No.: PCT/FR01/01626

(30) Foreign Application Priority Data
May 26, 2000 (FR) 00/06732

(51) Int. Cl. H04N 5/44; H04N 7/14

(52) U.S. Cl. 348/14.01; 348/725

(57) ABSTRACT

An apparatus such as a television receiver set, an encrypted programme decoder, etc., has, in particular on its remote control unit, a key (44) with multiple mobility for triggering repetitive reproduction, slightly delayed, of a most recent completed fragment of the sequence currently received live. The multiple mobility of the key (44) enables to parameterize the delayed reproduction for forward, rewind, slow motion, fast motion, picture-by-picture reproduction, the starting point of the delayed reproduction in the recorded fragment. The invention enables to acquire more accurate knowledge of details selected from a sequence occurring normally in real time.

### DESCRIPTION

The present invention relates to a repeating device for a receiving apparatus, in particular a video apparatus.

The present invention also relates to a receiving apparatus equipped with the repeating device.

The invention applies to apparatuses such as television receivers, encoded transmission decoders, telephones, videophones and, more generally, to apparatuses which comprise at least one function of receiving in real time a signal transmitted by an external source, at least one function of processing this signal and at least one function of immediate retrieval of the processed signal, by means of at least one interface, such as a TV screen or loudspeaker, with the user or the viewer.

The documents GB-A-2 222 742 and 2 328 825 teach the equipping of a receiver, in particular a television receiver, with a device allowing, by means of an internal memory and a control accessible to the user, a second slightly deferred retrieval of the most recent fragment, of predetermined duration, of the sequence currently being received in real time. The second retrieval, or repeating, can be carried out by as a keyed image or in place of the retrieval in real time, momentarily interrupted for this purpose.

The term “sequence” will hereafter refer to a relatively long succession of signals received and retrieved by the apparatus, for example a complete programme or the totality of a cinema film or, more generally, the totality of the signals received, processed and retrieved from the beginning up to the end of a period of use of the receiving apparatus by the user. The term “fragment” will refer to a part of the sequence, and in particular to the part of sequence that is stored and continuously updated by an apparatus having a repeating function. The term “element” of a sequence or of a fragment will refer to a set of signals forming a minimum consistent whole, for example a video image, a portion of music or of speech. The term “current element” of the sequence will refer to the element currently being received in real time by the receiving function and, (in the case of retrieval in real time), being retrieved by the retrieval function.

The known repeating devices allow the viewer/listener to see again/listen to again for at least a second time a fragment in which he is particularly interested or to which he would like to pay more attention than during the retrieval in real time.

Devices of this type comprise a memory of the “first in, first out” type (a FIFO memory) which records the current element and progressively erases the oldest element recorded in this memory, as a function of the maximum capacity of the memory, which corresponds for example to a fragment of about 30 seconds.

The known devices that have just been commented upon have not found a practical application for various reasons:

when the real time retrieval has not made it possible to perceive the level of detail desired by the user, the repeating of the fragment is also fruitless in principle, particularly if the deferred repeating is also carried out by keying, and therefore with a much smaller format;

the repeating takes place over the entire fragment whereas the user is generally interested only in one part of the latter;

after the repeating there is a problem with regard to connection with the real time retrieval.

The purpose of the present invention is to solve at least one of the problems mentioned above.

According to a first aspect of the invention, the repeating device for a receiving apparatus, in particular a video apparatus, comprising a memory of the first in first out type for storing at each instant of time a fragment preceding in a substantially adjacent manner the current element of the sequence that is in the process of being processed in real time, repeating means for providing the repeating, slightly deferred, of the retrieval of the stored fragment, and control means for selectively activating the repeating means, is characterized in that the control means comprise means of configuration of the deferred repeating.

The repeating means typically comprise means for feeding the retrieval means of the apparatus with signals coming from the memory instead of or in addition to those received at the current moment.

The configuration according to the invention can consist of an adjustment of the starting point of the repeating and/or an adjustment of the speed of repeating.

In order to adjust the starting point of the repeating, the control means can comprise a command for scanning the fragment in accelerated backward replay. This allows the viewer to return, within the recorded fragment, to a point located just upstream of the passage considered interesting.

In another version, in order to select the starting point of the repeating, the control means comprise a command for scanning element by element through the fragment, preferably with the successive elements separated from each other by a predetermined interval along the fragment. For example, the element by element scanning (for example image by image) is carried out by the repeated pressing of a key, each pressing causing the appearance of a new element separated, by a certain number of non-retrieved elements, of the element displayed as a consequence of the preceding pressing of the key. The user can thus carry out a fine locating in order to make the repeating start precisely at the desired point.

The means of configuration can make it possible to select the repeating speed from among one or more accelerated speeds and/or one or more slowed down speeds with respect to the normal retrieval speed.

It is also possible to envisage an element by element retrieval (typically: image by image) in forward play, all of the successive recorded elements in this case being preferably retrieved one after the other each time the user presses an appropriate control device.

According to another feature of the invention, the control means are designed in the form of a single multiple mobility key making it possible to enter the repeating process, to configure the repeating and to initiate the actual repeating.

By keeping a finger on this particular key of the remote control associated with a receiving apparatus, in particular a video apparatus, the viewer can very quickly and very freely, at any time, benefit from a deferred repeating, both targeted and detailed at the maximum performance of the apparatus, with regard to a very precise part of the fragment of predetermined size that is systematically recorded just upstream of the current element. A viewer can for example replay in detail a moment of a football match.

With regard to the configuration provided according to the invention, it would also be possible to envisage a zoom function, allowing a viewer to enlarge a desired part of the images of the repeated fragment.

According to another aspect of the invention, the device furthermore comprises means for storing a following fragment, received in real time, but hidden during the deferred repeating of the preceding fragment, and for the accelerated retrieval of the hidden fragment until catching up with the current element after the repeating process.

By means of this second aspect of the invention, a consistent connection is made between the repeating and the real time retrieval whilst minimizing the loss of information suffered by the user.

The invention also relates to a video receiving apparatus, such as a television set, equipped with a device of one of the types that have just been described.

Other features and advantages of the invention will furthermore emerge from the following description, relating to a non-limitative example.

In the appended drawings:

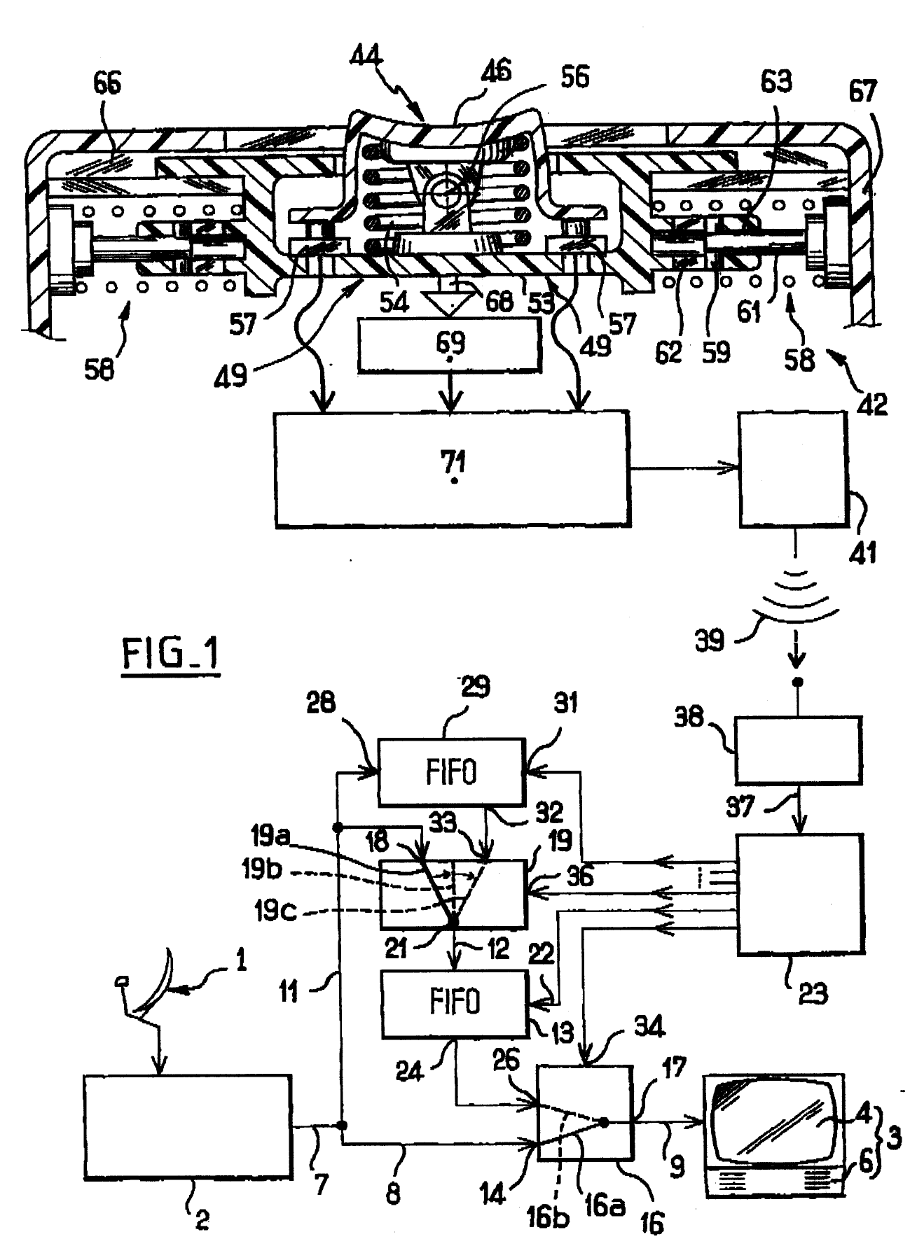

FIG. 1 is an exploded overall diagrammatic view of a receiving apparatus according to the invention, with an enlarged partial cross-section of the control means accessible to the user;

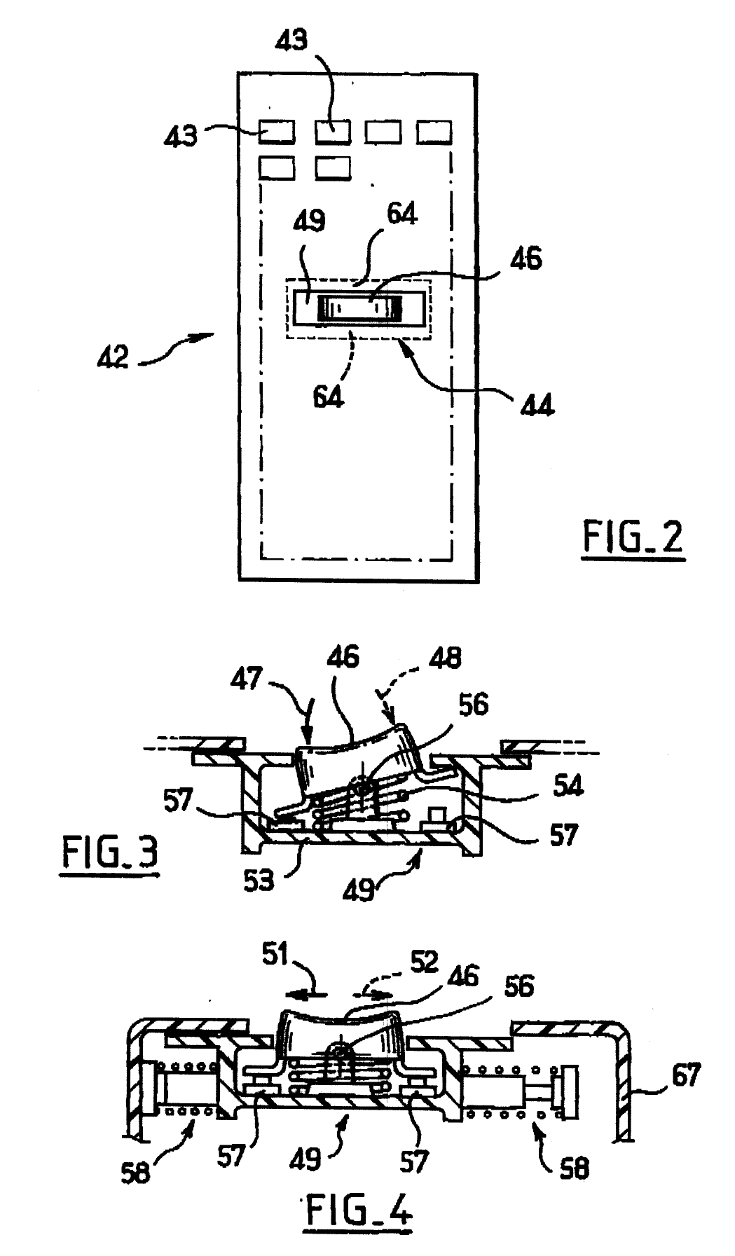

FIG. 2 is a front view of the remote control unit of the apparatus shown in FIG. 1;

FIGS. 3 and 4 are two partial views in cross-section giving a diagrammatic representation of two different mobility functions of the single multiple mobility key provided on the remote control unit.

In the example shown in FIG. 1, the video retrieval apparatus is a television set comprising a receiving antenna 1, a signal processing unit 2 and retrieval means 3 comprising a screen 4 and loudspeakers 6. The multi-wire output 7 of the signal processing unit 2 is divided into a branch 8 which is normally connected to a signal input 9 of the retrieval means 3 and a branch 11 selectively connected to the input 12 of a first FIFO memory 13. For the selective connection of the signal output 7 of the unit 2 to the signal input 9 of the retrieval means 3, the branch 8 is connected to a first input 14 of a first switch 16 whose common output 17 is connected to the input 9.

For the selective connection of the output 7 of the unit 2 to the input 12 of the first FIFO memory 13, the branch 11 is connected to a first input 18 of a second switch 19 whose common output 21 is connected to the input 12 of the first FIFO memory 13. The first FIFO memory 13 comprises a control input 22 connected to a control unit 23, and a read output 24 connected to the other input 26 of the first switch 16.

The signal output 7 of the processing unit 2 is furthermore connected by the branch 11 to the input 28 of a second FIFO memory 29 which has, for example, the same capacity as the first FIFO memory 13. The second FIFO memory 29 has a control input 31 connected to the control unit 23 and a read output 32 connected to the other input 33 of the second switch 19.

Each of the two switches 16 and 19 comprises a respective control input 34, 36 connected to the control unit 23.

For direct (real time) retrieval operation, the first switch 16 is in the state 16a in which it connects the output 7 of the processing unit 2 directly to the retrieval means 3 and the second switch 19 is in the state 19a in which it connects the signal input 12 of the first FIFO memory 13 to the signal output 7 of the processing unit 2. Consequently, the two FIFO memories 13 and 29 have the same content, updated continuously in order to correspond to a fragment of predetermined duration which precedes in an adjacent manner the current element which is in the process of being received and retrieved directly.

When the control means, yet to be described, command the starting of the repeating procedure, the control unit 23 causes the second switch 19 to switch into an intermediate position 19b isolating the signal input 12 of the first FIFO memory 13. The latter thus temporarily becomes a kind of read only memory. At the same time, the control unit 23 switches the first switch 16 into its position 16b as represented in dotted line connecting the read output 24 of the first FIFO memory 13 to the signal input 9 of the retrieval means 3. The output 24 of the first FIFO memory 13 transmits signals determined by control signals sent by the control unit 23 to the control input 22 of the memory 13. Thus, depending on the control signals that it receives itself, the control unit 23 selects in the FIFO memory 13 the elements which must be delivered to the output 24 for retrieval by the retrieval means 3. During this time, the real time signals available at the output 7 of the processing unit 2 continue to be stored in the second FIFO memory 29.

At the end of the repeating procedure, the control unit 23 switches the second switch 19 into its third position 19c connecting the signal input 12 of the first FIFO memory 13 to the signal output 32 of the second FIFO memory 29. The first FIFO memory 13 starts being updated again, but with signals chosen in the second FIFO memory 29 in order to be in correct chronological succession starting with the most recent signals stored in the first FIFO memory 13 just before the start of the repeating process. This choice is made by the control unit 23 via the control input 31 in the second FIFO memory 29.

During this transient phase, or catching-up phase, the user is invited, for example by a sensory signal, to initiate an accelerated retrieval. All of the elements prior to an element read in this catching-up phase are deleted from the first memory 13 whilst the memory 29 contains elements that have not yet been transferred to the memory 13.

The memory 13 is therefore updated in an accelerated manner with the content of the second memory 29, beginning with the oldest part of that content. This process continues until the element read in the first FIFO memory 13, for retrieval by the means 3, is the most recent that is entered in it and the latter itself corresponds to the most recent element entered into the second FIFO memory 29. At this stage, the control unit 23 switches the two switches 16 and 19 into their respective first positions 16a, 19a. The functioning of the direct retrieval then begins as initially described. The above description has shown that the switches 16 and 19 and the control unit 23 are part of the repeating means in the sense of the invention.

However, the control unit can also have other control functions of the receiving apparatus, with no direct relation to the invention, such as the adjustment of the sound volume, of the image, channel selection, etc.

Furthermore, the switch 16 and the first FIFO memory 13 are also part of the catching-up means, in combination with the third state 19c of the switch 19 and with the second FIFO memory 29.

The control means allowing the user-viewer to initiate the different operational stages that have just been described will now be described.

The control unit 23 comprises an input 37 connected to the output of a receiver of infra-red signals 38 sensitive to the infra-red signals transmitted by the transmitter 41 of a remote control unit 42.

As shown in FIG. 2, the remote control unit 42, which is the one furthermore making it possible, in a conventional manner, to control all of the functions of the television set or even, as a variant, the remote control unit making it possible to control a decoder of encoded transmissions, conventionally comprises many conventional keys 43 that will not be described in detail. The unit 42 furthermore comprises a multiple mobility key 44 making it possible for it alone to initiate the repeating process, to configure the repeating and to initiate the repeating itself, the catching up and then finally the return to direct retrieval operation. The multiple mobility key 44 comprises a rocker 46 that can rock laterally in one direction or the other (see the arrows 47 and 48 in FIG. 3) starting from a central position of rest illustrated in FIGS. 1 and 4. The rocker 46 is itself mounted on a sliding carriage 49 able to slide laterally in one or the other direction (see the arrows 51 and 52 in FIG. 4) starting from a central position of rest represented in FIGS. 1 to 3.

In order that it may slide, the carriage 49 comprises lateral edges 64 (FIG. 2) travelling in slides 66 (FIG. 1) integral with the shell 67 of the remote control unit 42.

Between the rocker 46 and a bottom 53 of the carriage 49 there is a compression spring 54 for which the position of rest of the rocker 46 corresponds to a state of least deformation. The rocker 46 is connected to the bottom 53 by an articulation 56 defining its rocking axis. Depending on whether the rocker 46 is rocked in one direction or in the other direction (FIG. 3) starting from its position of rest, it actuates one or other of two micro-switches 57 mounted on the bottom 53 of the carriage 49.

The carriage 49 is mounted between two jacks 58 with compression springs 58 of limited expansion, which are both in their state of maximum expansion when the carriage 49 is in the central position shown in FIGS. 1 to 3. When the carriage 49 is pushed laterally in one direction or the other starting from its central position, as shown in FIG. 4, the respective one of the jacks 58 (the left hand jack in FIG. 4) is compressed. The other jack 58 follows the movement of the carriage 49 without modifying its maximum state of expansion defined by pins 59 (FIG. 1) fixed to the rod 61 of the jack and sliding in openings 62 formed in the body 63 of the jack. The carriage 49 carries a cursor 68 whose position, determined by the position of the carriage 49 along its sliding movement, is converted into an electrical signal by a converter 69, for example of the rheostat type. The output signals of the converter 69 and of the two micro-switches 57 are picked up by a processing unit 71, which can also process the signals received from other keys 43 of the remote control unit and which controls the transmitter 41.

By way of example, it is possible to provide the following functional modes:

starting from the direct retrieval functioning, any action on the multiple mobility key 44 initiates the repeating process, that is to say the switching of the two switches 16 and 19 into their second positions 16b, 19b;

then, by pushing the carriage 49 towards the left, a playback in reverse of the fragment captured in the first FIFO memory 13 is initiated, the speed being slowed down or accelerated depending on whether the carriage is pushed more or less distant towards the left;

any rocking of the rocker 46 towards the left as indicated by the arrow 47 (FIG. 3) causes the appearance of a fixed image located at an interval corresponding to ten images upstream of the last image displayed;

rocking the rocker 46 towards the right, (arrow 48 in FIG. 3) causes the fixed-image display of the image that immediately follows the previously displayed image;

the displacement of the carriage 49 towards the right (arrow 52 in FIG. 4) causes the deferred retrieval, faster or slower in forward play, at a speed ranging from slowed down to accelerated depending on whether the carriage is pushed more or less distant towards the right;

the complete release of the multiple mobility key 44 allows the natural deferred retrieval, that is to say at normal speed and with sound: the control unit 23 is in fact capable of distinguishing this situation, where the two switches 16 and 19 are each in their second state 16b, 19b, from the direct retrieval situation, which is also the result of an absence of actuation of the key 44, but when the two switches 16 and 19 are in their first state 16a,16b as represented in full line in FIG. 1;

in order to return to direct retrieval, the user-viewer pushes the carriage 49 towards the right (the arrow 52 in FIG. 4) in order to cause an accelerated retrieval, until it has caught up with the current image, which the user observes because the accelerated retrieval stops itself by the exhausting of the content of the second FIFO memory 29. The user then releases the key 44 and the switches 16 and 19 switch back, one of them from the second position to the first position and the other one from the third position to the first position in order to resume operation in direct retrieval. A signal can appear on the screen in order to incite the user to release the key 46.

The invention is not of course limited to the example described and shown.

It would be possible to make provision for the device, starting from the functioning in direct retrieval, to return immediately to the oldest image contained in the first FIFO memory 13, the searching for the start point of the deferred playback desired by the user then being carried out in forward play.

The switch 16 and the branch 8 could be eliminated. The playing in real time would take place starting from the most recent element contained in the FIFO memory 13. The read output 24 would therefore be connected directly to the signal input 9 of the means 3.

The invention is applicable to an apparatus other than a video apparatus, for example to a telephone or to radio-telephone apparatus. For example, with a telephone, one of the speakers having poorly understood the words of his correspondent can ask the latter for an interruption of the conversation. Holding music can be activated whilst the first speaker, after having searched for the unclear passage using the fast search means of the type described for the video apparatus, listens to this passage again as often as necessary.

The memories and the switches have been shown in the form of physical and/or discrete components only by way of illustrative example. In practice, it will be possible to use, for example, only one single memory comprising at least two compartments with areas whose loading, erasure, transfers and readout are controlled by computer means at least partly belonging to the unit 23.

1. A repeating device for a receiving apparatus, in particular a video apparatus, comprising a memory of the first in first out type (13) for storing at each instant of time a fragment preceding in a substantially adjacent manner a current element that is being processed in real time, repeating means (16, 19, 23) for providing slightly deferred repeating of the retrieval of the stored fragment, and control means (38, 41, 69, 71) for selectively activating the repeating means, said control means comprising configuration means (44, 57, 69) for configurating the deferred repeating, characterized in that the control means are designed as a single multiple mobility key (44) making it possible to enter the repeating process, to configure the repeating and to initiate the actual repeating.

2. A device according to claim 1, characterized in that the configuration means (44, 57, 69) make it possible to select in the fragment an element starting from which the retrieval of the fragment is repeated.

3. A device according to claim 2, characterized in that the control means comprise, in order to select said element of the fragment, a control (47, 51) for retrieval of the fragment in accelerated reverse play.

4. A device according to claim 2 or 3, characterized in that the control means comprise, in order to select said element, means (47, 48) of scanning the fragment element by element.

5. A device according to claim 4, characterized in that the element by element scanning is carried out automatically as a succession of elements separated from each other by a predetermined interval along the fragment.

6. A device according to claim 4 or 5, characterized in that the element by element scanning is carried out by successive actuations of a control (46), each one causing retrieval of a new element located at a predetermined interval upstream of the element of the preceding retrieval.

7. A device according to one of claims 1 to 6, characterized in that the configuration means (44, 57, 69) make it possible to select deferred retrieval speed.

8. A device according to claim 7, characterized in that the configuration means (44, 57, 69) make it possible to select an accelerated retrieval speed for the repeating.

9. A device according to claim 7 or 8, characterized in that the configuration means (44, 57, 69) make it possible to select a slowed down retrieval speed for the repeating.

10. A device according to one of claims 1 to 9, characterized in that it furthermore comprises means (29) for storing a following fragment received in real time but hidden during the deferred repeating of the preceding fragment, and for retrieving the hidden fragment in accelerated mode until the catching up with the current element after the repeating process.

11. A receiving apparatus equipped with a device according to one of claims 1 to 10.
